(19) United States
(12) Patent Application Publication
(10) Pub. No.: US 2013/0098142 A1
(43) Pub. Date: Apr. 25, 2013

(54) METHOD AND DEVICE FOR MEASURING AEROSOLS IN A LARGE VOLUMETRIC STREAM

(71) Applicants: Achim Trimborn, Leichingen (DE); Stefan Trimborn, Selb (DE)

(72) Inventors: Achim Trimborn, Leichingen (DE); Stefan Trimborn, Selb (DE)

(21) Appl. No.: 13/654,038

(22) Filed: Oct. 17, 2012

Related U.S. Application Data
(60) Provisional application No. 61/550,392, filed on Oct. 22, 2011.

(30) Foreign Application Priority Data
Oct. 20, 2011 (DE) 10 2011 054 659.6

(51) Int. Cl. G01N 21/17

(52) U.S. Cl. 73/28.01

(57) ABSTRACT

The invention discloses a particle measurement device (1) having at least one particle concentration device (2a, 2b, 2c), having a particle detection device (8a, 10a, 8b, 10b, 8c, 10c), adapted to detect particles in a volume stream. The particle concentration device further comprises a detection device (36a, 36b, 36c) adapted to detect undesired particles. The particle concentration device further comprises a separation device (22a, 22b, 22c) adapted to separate undesired particles from the volume stream.

### CROSS-REFERENCE TO RELATED APPLICATION(S)

This application claims the benefit of U.S. Provisional Patent Application Ser. No. 61/550,392, filed Oct. 22, 2011, the entirety of which is hereby incorporated herein by reference.

This application claims the benefit of German Patent Application No. 10 2011 054 659.6, filed Oct. 20, 2011, the entirety of which is hereby incorporated herein by reference.

### BACKGROUND OF THE INVENTION

1. Field of the Invention

The present invention relates to a method and device for measuring aerosol particles in a large volumetric stream

2. Description of the Related Art

Aerosol particles can be detected, e.g., in a photo-ionization detector in a mass spectrometer or an ion mobility spectrometer, to name just a few possibilities. The detectors have the disadvantage of only being able to analyze relatively small air streams. As a result, the aforementioned detectors cannot simply be used if a large air stream is to be analyzed, as, for example, is required in the case of an NBC detection vehicle.

DE 198 44 605 A1 discloses a “skimmer” and an orifice, through which the aerosol stream passes. Aerosol-free air is vacuumed off using two low-pressure chambers, and the aerosol particles pass through the orifice to a detector. This allows for concentration of the particle stream in the air stream, supplying a relatively small air stream to a detector.

Another possibility for concentrating the aerosol particle stream is a virtual impactor, as disclosed in DE 44 150 14 C2. The volume stream containing particles is accelerated by nozzles in a transmitter plate in the direction of a receiver plate with an opening. The accelerated particles pass through the opening in the receiver plate due to their mass inertia, whilst the gas moves off to the side.

Furthermore, aerodynamic lenses can be used for particle concentration. An aerodynamic lens consists of multiple apertures, sized such that the aerosol particles form a convergent particle beam upon leaving the lens. Furthermore, at the last aperture of the lens, there is such a substantial drop in pressure that an ultrasound expansion can form, accelerating the particle into a detection area.

Therefore, there is a need for an improved method and device for analyzing aerosol-containing gas streams.

### SUMMARY OF THE INVENTION

The disadvantages of the prior art are overcome by the present invention which, in one aspect, is a method for measuring particles in a volume/air stream, comprising the steps of detecting particles in a volume stream, detecting undesired particles, and separating undesired particles out of the volume stream. The detection of particles in the volume stream may comprise the detection of the fluorescent radiation of the particle. The particles may be stimulated with a laser beam, and a fluorescence detection device may determine particle type based on the fluorescence of the particle. A control device may control a valve, which separates or conducts away the undesired particles from the volume stream. The control device may thus control the separation of undesired particles from the volume stream.

The term “volume stream” also encompasses a gaseous mixture, e.g., air with particles and/or aerosols. The term “particle” also encompasses aerosols.

After the detection of particles in the volume stream and before separating undesired particles, the volume stream may pass through a chamber having a lower pressure in which part of the volume stream is vacuumed off. It is to be understood that the chamber must be open to a low pressure source so that part of the volume stream can be vacuumed off (sucked off). After detecting the particles in the volume stream, the volume stream may pass through a nozzle before entering the chamber. In the chamber, part of the volume stream is vacuumed off by the low pressure. Because the particles have a greater mass inertia, they may enter a conduit through a second nozzle, in which the valve is located that can separate out undesired particles.

Using the method disclosed by the invention, volume streams of several m³/min can be concentrated to volume streams of approximately 100 ml/min. This concentrated volume stream can be passed to a conventional detector, such as, a mass spectrometer, a fluorescence detector etc. Thus, the method according to the present invention allows for the particles to be concentrated from a large volume stream, such that they can be detected by a conventional detector if they are in a relatively small volume stream. Furthermore, the method according to the present invention allows for particles, the detection of which is not desired, not to reach the detector.

The separation of the undesired particles has the advantage that the detector is not compromised by undesired particles, and that the only particles to enter the detector are those that are in fact meant to be detected.

The aforementioned steps concentrate the particle stream. The aforementioned steps may be carried out multiple consecutive times.

The particles can be impacted into a fluid matrix. To this end, an organic or inorganic matrix can be used. Upon impaction, the particle strikes the matrix, and is absorbed by it, such that, in the rest of the process, the matrix is the carrier medium for the particle.

The particles in the matrix can be nebulized or dispersed. Because the matrix is liquid at this time, it can be dispersed by standard methods, e.g., nebulizer, atomizer, ultrasound nebulizer.

The matrix can also be dripped onto standard targets and submitted.

The matrix can be an organic acid (MALDI). MALDI is the abbreviation for matrix-assisted laser desorption/ionization, and the method is known to a person skilled in the art. An acid present in a 100- to 100,000-fold molar surplus compared to the molecules to be analyzed may be used as the matrix material. The matrix is irradiated with a laser light source, separating the molecules to be analyzed and the matrix molecules from the carrier. The molecules arising in this process can be detected by a mass spectrometer.

The object of the invention is also solved by way of a particle concentration device with a particle detection device, arranged to detect particles in a volume stream. The particle concentration device further comprises a detection device adapted to detect undesired particles. Furthermore, the particle concentration device comprises a separation device arranged to separate undesired particles from the volume stream.

The particle concentration device may further be formed in the manner described with regard to the method. The method may be further arranged as described below for the particle concentration device and particle measuring device.

The particle detection device may be arranged to detect particles by means of fluorescent radiation. The particles may be stimulated by a laser beam, and a fluorescence detection device may be used to measure the particle type. A control device (detection device) may control a fast valve that separates out undesired particles based on the particle type. This ensures that only those particles reach the detector that are meant to be detected.

The volume stream can first pass through the particle detection device and then a chamber with low pressure in which part of the volume stream is vacuumed off. After the lower-pressure chamber, the volume stream may enter the separation device. After the particle detection device, the volume stream may pass through a nozzle before entering the lower-pressure chamber. From the lower-pressure chamber, the volume stream may enter a second conduit via a nozzle. The chamber may be connected to a lower pressure source. Due to the lower pressure, the gas is vacuumed off; on the other hand, the particle stream is sent from the first nozzle to the second nozzle, because it has a higher mass inertia.

The separation device can be a fast valve, controlled by the aforementioned control device that uses the results of the particle detection system in order to detect undesired particles. Accordingly, the control system can be adapted as a detection system.

The invention also discloses a particle measurement device having at least one particle concentration device. In the particle measurement device, several particle concentration devices can be arranged one after another, such that the gas beam passes through multiple consecutive particle concentration devices.

The particle measurement device can include an impaction system, adapted to impact the particles in the volume stream in a matrix. The matrix can be an organic or inorganic matrix. The matrix can be acid, such as, an inorganic acid, with a high molar surplus compared to the particles. However, metal particles, such as gold or silver particles, in particular in the form of nanoparticles, can also be used. The particles are impacted in the matrix by the impaction device after having passed through at least one particle concentration device.

The particle measurement device can have a particle nebulization device adapted to nebulize or disperse the impacted particles. The nebulization device can be a laser. Due to the negative pressure, the particles are pulled after nebulization or dispersion into a detector adapted to analyze the particles. The detector may be, e.g., a mass spectrometer, a laser spectrometer, a fluorescence spectrometer, etc.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of one embodiment.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

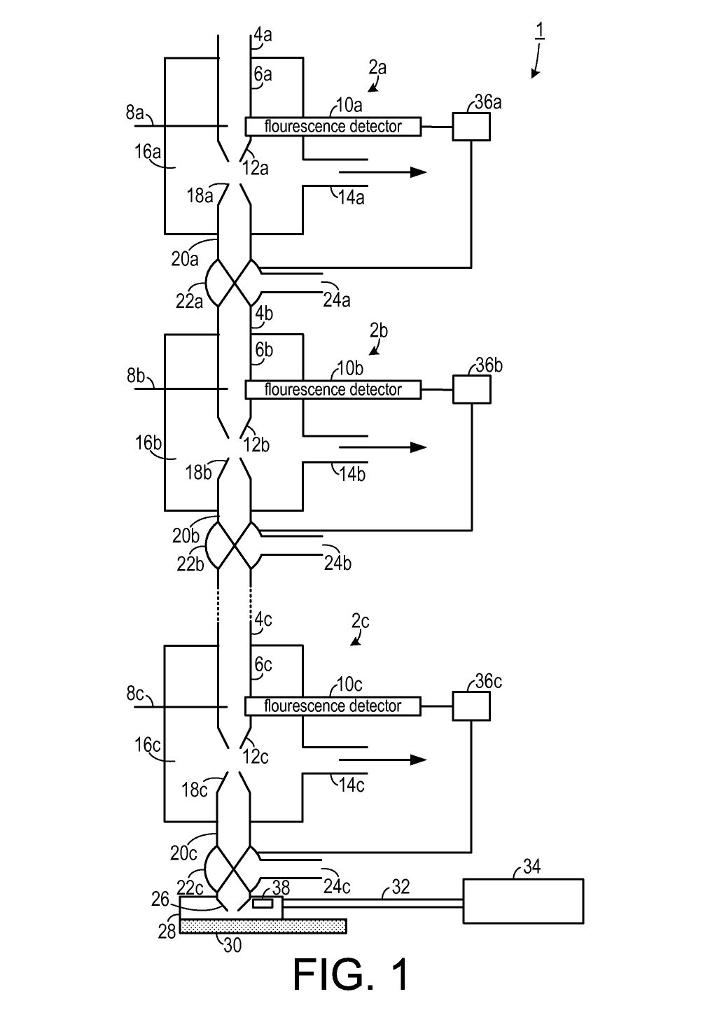

The invention will now be discussed by reference to FIG. 1, which shows a non-limiting embodiment of the invention.

FIG. 1 shows a particle measurement device 1 having several consecutively arranged particle concentration devices 2a, 2b, 2c, an impaction device 28, and a detector 34. Each of the particle concentration devices 2a, 2b, 2c concentrates the particle stream, removing undesired particles. By removing undesired particles, only those particles in the focus of the study are ultimately supplied to a detector for examination. Furthermore, the initial volume stream can be reduced by multiple powers of ten.

Because the particle concentration devices 2a, 2b, 2c are substantially similar in structure, by way of example, the first particle concentration device 2a is discussed; on the other hand, in the sake of conciseness, the second particle concentration device 2b and the third particle concentration device 2c will only be discussed to a lesser extent.

The first particle concentration device 2a has an inlet 4a adapted to absorb a volume stream of several m³/min. This volume stream passes through a first inlet line 6a, in which the particles/aerosols are irradiated by a first laser 8a. A first fluorescence detection device 10a determines the fluorescent radiation emitted by the aerosols/particles.

The volume stream enters a first chamber 16a, in which there is negative pressure, via a first outlet nozzle 12a. This vacuums off part of the volume stream through the first suction line 14a. Because the particles/aerosols have a higher mass inertia, they move from the first outlet nozzle 12a to the first inlet nozzle 18a through the first chamber 16a. The overall arrangement substantially constitutes a virtual impactor. However, systems with a nozzle and a skimmer are also possible, as are other geometries.

From the first inlet nozzle 18a, the particles move in a volume stream to a first drainage line 20a. The first drainage line leads the particle stream to a first valve 22a. The first valve 22a is also connected with a first output line 24a. If a first detection device (first control device) 36a detects that the particle detection device (fluorescence detection device) 10a has detected an undesired particle, the detection device 36a sends a signal to the first valve 22a, causing the valve 22a to dischange the undesired particles/aerosols through the first separation line 24a. The valve has a switching time of approximately 0.1 msec to approximately 2 msec. The valve can be, e.g., a magnetic valve, a cartridge valve, a pneumatic valve, a piezo injector etc. The faster the valve is, the shorter the distance can be between the fluorescence detection device 10a and the valve. The faster the valve is, the faster the volume stream in the first drainage line 20a can be.

It can only be determined based on the specific use whether a particle is desired or not. Generally, the detection of organic and/or biological particles is desired, and the detection of inorganic materials is undesired.

The first valve 22a is connected to a second inlet 4b, such that the volume stream with the particles flows through the second inlet 4b into the second inlet line 6b. The particles in the second inlet line 6b are irradiated with a second laser 8b. A second detection device/fluorescence detection device 10b determines the particle type based on the fluorescent radiation of the particles irradiated with the second laser 8b, sending this to the second detection device/control device 36b. The volume stream enters a second chamber 16b via a second outlet nozzle. Part of the gas stream is vacuumed off by a second suction line 14b. Due to their mass inertia, the aerosol particles enter a second inlet nozzle 18b, guides the reduced volume stream into the second drainage line 20b. A second valve 22b purges undesired particles via the second separation line 24b, as described above with regard to the first particle concentration device 2a. The functioning of the second particle concentration device 2b corresponds to that of the first particle concentration device 2a; thus, a detailed description of it is omitted here for the sake of concision.

The second valve 22a is connected to a third inlet 4c, such that the volume stream with the particles flows through the third inlet 4c into the third inlet line 6c. The particles in the third inlet line 6c are irradiated with a third laser 8c. A third detection device/fluorescence detection device 10c determines the particle type based on the fluorescent radiation of the particles irradiated with the third laser 8c, transmitting the same to the third detection device/control device 36c. The volume stream enters a third chamber 16c, in which there is negative pressure, via a third outlet nozzle. Part of the gas stream is vacuumed off by a third suction line 14c. Due to their mass inertia, the aerosol particles enter a third inlet nozzle 18c, which transferring the reduced volume stream into the third drainage line 20c. A third valve 22c purges undesired particles via the third separation line 24c, as described above with regard to the first particle concentration device 2a. The operation of the third particle concentration device 2c is equivalent to that of the first particle concentration device 2a; thus, for the sake of conciseness, a detailed description of it is not provided here. It is to be understood that more than three particle concentration devices can be arranged one after another.

The third valve 22c is connected with dosing nozzle 26, which transfers the particles to an impactor device 28. In the impactor device 28, the particles are impacted in a matrix 30. The matrix can be an organic or inorganic matrix. Examples of organic matrices are DHB (dihydroxybenzoic acid), sinapic acid, and nicotinic acid. Examples of inorganic matrices are gold or silver particles.

The particle measurement device further comprises a nebulization device 38, which, e.g., is formed as an ultrasound emitter or atomizer (air stream through or via a capillary). This separates drops from the matrix, with the matrix material separating from the particle when the particle is in the gas.

Via a detector supply line 32, in which negative pressure is present, the particles are sent to the actual detector 34.

The detector supply line 32 contains a volume stream of approximately 100 ml/sec to approximately 200 ml/sec.

The detector may be a mass spectrometer or an ion mobility spectrometer with a photoionisation detector.

The particle measurement device according to the invention can concentrate a volume stream and separate out undesired particles, so that the detector 34 is not compromised by undesired particles. The possible types of detectors are only listed as non-limiting examples, wherein, further detector types are possible. The invention has the advantage that desired particles can be concentrated. This supplies only desired particles to the connected analyser, in order to make optimal use of it.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for measuring particles in a volumetric gas stream, having the following steps:
(a) detecting particles in a volume stream;
(b) detecting undesired particles; and
(c) separating undesired particles from the volume stream by a valve, wherein after the detection of particles in the volume stream and before separating undesired particles, the volume stream passes through a chamber having lower pressure in which part of the volume stream is vacuumed off.

2. The method according to claim 1, wherein the step of detecting particles in the volume stream comprises the step of determining the fluorescent radiation of the particle.

3. The method according to claim 1, wherein the steps of claim 1 are carried out multiple consecutive times.

4. The method according to claim 1, further comprising the step of impacting the particles into a matrix.

5. The method according to claim 4, characterized by the step of nebulizing or dispersing the particles impacted in the matrix.

6. The method according to claim 1, further comprising the step of analyzing the particles.

7. A particle concentration device, comprising:
(a) a particle detection device adapted to detect particles in a volume stream;
(b) a detection device adapted to detect undesired particles; and
(c) a valve adapted to separate undesired particles from the volume stream, wherein the particle concentration device is adapted such that the volume stream first passes through the particle detection device and then into a chamber having lower pressure, in which part of the volume stream is vacuumed off, and enters the separation device after the lower-pressure chamber.

8. The particle concentration device of claim 7, wherein the particle detection device is adapted to detect particles by means of fluorescent radiation.

9. A particle measurement device including at least one particle concentration device according to claim 7, whereby several particle concentration devices are arranged one after another, such that the gas beam passes through multiple particle concentration devices consecutively.

10. The particle measurement device according to claim 9, further comprising an impactor device adapted to impact the particles in the volume stream in a matrix.

11. The particle measurement device according to claim 10, further comprising a nebulization device adapted to nebulize or disperse the impacted particles.

12. The particle concentration device of claim 7, further comprising a detector adapted to analyze the particles.
